(19) United States
(12) Patent Application Publication
(10) Pub. No.: US 2022/0405495 A1
(43) Pub. Date: Dec. 22, 2022

(54) LASER ENGRAVER WITH BARCODE READING MODULE

(71) Applicants: INVENTEC (PUDONG) TECHNOLOGY CORPORATION, Shanghai (CN); INVENTEC CORPORATION, Taipei City (TW)

(72) Inventor: Mogang LI, Shanghai (CN)

(21) Appl. No.: 17/468,130

(22) Filed: Sep. 7, 2021

(30) Foreign Application Priority Data
Jun. 16, 2021 (CN) 202110669601.1

(51) Int. Cl. G06K 7/14

(52) U.S. Cl. CPC G06K 7/1417

(57) ABSTRACT

A laser engraver with a barcode reading module is disclosed which is for engraving 2D barcode on an electronic component positioned in an engraving area. The laser engraver includes a motion assembly, a laser beam generator, a control module and a barcode reading module. The motion assembly is operative to move in first and second horizontal directions. The control module is configured to control the laser beam generator to produce a laser beam which engraves 2D barcode on the electronic component, and to control the barcode reading module to read 2D barcode. In the event of a count of unsuccessful attempts of the barcode reading module to read 2D barcode reaching a built-in failure count, the control module produces a warning signal, thereby ensuring successful reading of 2D barcode by client, avoiding the problems arising from failure in such reading, including downtime of a production line and the resulting fines.

### CROSS-REFERENCES TO RELATED APPLICATION

This application claims the priority of Chinese patent application number 202110669601.1, filed on Jun. 16, 2021, the entire contents of which are incorporated herein by reference.

### TECHNICAL FIELD

The present invention relates to an apparatus and, in particular, to a laser engraver with a barcode reading module.

### BACKGROUND

In-factory fabrication of some printed circuit boards (PCBs) involves engraving two-dimensional (2D) barcodes on the PCBs using laser engraving or marking machines. Such 2D barcodes may encode some information of the PCBs, such as their serial numbers.

Generally, finished PCBs are delivered from a manufacturer's factory to the client who placed the order and assembled at the client's premise for the purpose of their intended use. Before delivery to the client, the manufacturer's staff may read the 2D barcodes on the PCBs using the manufacturer's own barcode reading device to ensure that the barcodes can be correctly read by the device. Moreover, when receiving the PCBs, the client's staff may also read the 2D barcodes using the client's own barcode reading device to retrieve information that the barcodes represent.

However, since the various existing barcode reading devices, such as CCD cameras, Honeywell barcode scanners and Keyence's compact fixed-mount barcode readers, have varying 2D barcode identification characteristics, and due to the fact that the readability of a 2D barcode is possibly affected by the green solder mask coating on the PCB and the parameters of the laser beam used, it is probable that a client's barcode reading device cannot read 2D barcodes on PCBs received from a manufacturer. Additionally, many domestic manufacturers are producing PCBs for foreign clients. If such PCBs cannot be read by a foreign client's barcode reading device and finally lead to failure in assembly and downtime of the client's production line, the domestic manufacturer may face huge fines. Therefore, still further improvement would be desirable in the art.

### SUMMARY OF THE INVENTION

In order to overcome at least one of the various prior-art problems arising from the use of different barcode reading devices by the manufacturer and the client, it is a primary objective of the present invention to propose a novel laser engraver with a barcode reading module.

The proposed laser engraver is for engraving a 2D barcode on an electronic component positioned in an engraving area and includes a motion assembly, a laser beam generator, a control module and a barcode reading module. The motion assembly is operative to move in a first horizontal direction and a second horizontal direction. The laser beam generator is coupled to the motion assembly and is operative to move above the engraving area, generate a laser beam that engraves the 2D barcode on the electronic component, and after the engraving of the 2D barcode is completed, produce a signal indicative of the completion. The control module is electrically connected to the laser beam generator and is configured to produce a barcode read signal upon receiving the signal indicative of the completion. The barcode reading module is operative to, upon receiving the barcode read signal, move above the engraving area, read the 2D barcode, and in the event of the reading being successful, providing the read information. When a count of unsuccessful attempts to read the 2D barcode reaches a built-in failure count, the control module produces a warning signal.

Optionally, the motion assembly may include a first rod and a second rod. The first rod may be operative to cause the laser beam generator to move in the first horizontal direction. The second rod may be coupled to the first rod and operative to cause the laser beam generator to move in the second horizontal direction.

Optionally, both the first and second rods may be ballscrew rods.

Optionally, the motion assembly may include a set of servo motors, which are electrically connected to the control module and configured to drive the first and second rods to move under the control of the control module.

Optionally, the set of servo motors may include a first servo motor for driving the first rod and a second servo motor for driving the second rod.

Optionally, the control module may include a receiving unit, a processing unit and a warning unit. The receiving unit may be electrically connected to both the laser beam generator and the barcode reading module and configured to receive the signal indicative of the completion, the read information and the count of unsuccessful attempts of the barcode reading module to read the 2D barcode. The processing unit may be electrically connected to the receiving unit and configured to receive and process the signal indicative of the completion, the read information and the count of unsuccessful attempts of the barcode reading module to read the 2D barcode. The warning unit may be electrically connected to the processing unit and configured to produce the warning signal in the event of the processing unit determining that the count of unsuccessful attempts to read the 2D barcode reaches the built-in failure count.

Optionally, the control module may further include a storage unit, which is electrically connected to the processing unit and configured to store the read information received by the processing unit.

Optionally, the control module may further include a control unit, which is electrically connected to the processing unit and configured to control the motion assembly to move in the first and second horizontal directions, control the laser beam generator to generate the laser beam, and upon the processing unit receiving the signal indicative of the completion, control the barcode reading module to move above the engraving area and read the 2D barcode.

Optionally, the control module may further include a configuration unit, which is electrically connected to the processing unit and configured to configure the built-in failure count for the barcode reading module.

Optionally, the laser engraver may further include a fastener attaching the laser beam generator to the barcode reading module.

In summary, compared to the prior art, the barcode reading module in the proposed laser engraver can preliminarily read a 2D barcode engraved by the laser beam generator, and when failure in reading is determined, a warning signal can be produced to indicate that the created 2D barcode is problematic, possibly followed by troubleshooting by a technician on the site. In other words, if the preliminary reading of a 2D barcode by the barcode reading module succeeds, it means that the 2D barcode can also be successfully read by the client. This can solve the prior-art problems arising from failure in reading of 2D barcodes C by a client, including downtime of a production line and the resulting fines.

### BRIEF DESCRIPTION OF THE DRAWINGS

FIG. 1 is a schematic stereoscopic view of an embodiment of the present invention.

FIG. 2 is a diagram schematically illustrating the movement of a laser engraver toward an engraving area according to an embodiment of the present invention.

FIG. 3 is a diagram schematically illustrating the generation of a laser beam by a laser beam generator according to an embodiment of the present invention.

FIG. 4 is a diagram schematically illustrating the engraving of a two-dimensional (2D) barcode by the laser beam generator according to an embodiment of the present invention.

FIG. 5 is a diagram schematically illustrating the movement of a barcode reading module according to an embodiment of the present invention.

FIG. 6 is a diagram schematically illustrating the reading of the 2D barcode by the barcode reading module according to an embodiment of the present invention.

FIG. 7 shows a block diagram of the laser engraver incorporating the barcode reading module according to an embodiment of the present invention.

In these figures, 1—laser engraver with the barcode reading module; 11—motion assembly; 111—first rod; 112—second rod; 113—first servo motor; 114—second servo motor; 115—first slide member; 116—second slide member; 12—laser beam generator; 13—control module; 131—receiving unit; 132—storage unit; 133—processing unit; 134—warning unit; 135—control unit; 136—configuration unit; 14—barcode reading module; 15—fastener; A—engraving area; C—2D barcode; D1—first horizontal direction; D2—second horizontal direction; E—electronic component; L—laser beam.

### DETAILED DESCRIPTION

Embodiments of the present invention will be described in greater detail below with reference to the appended schematic drawings. Advantages and features of the present invention will become more apparent from the following description and from the appended claims. Note that the figures are provided in a very simplified form not necessarily drawn to scale for the only purpose of helping to explain the disclosed embodiments in a more convenient and clearer way.

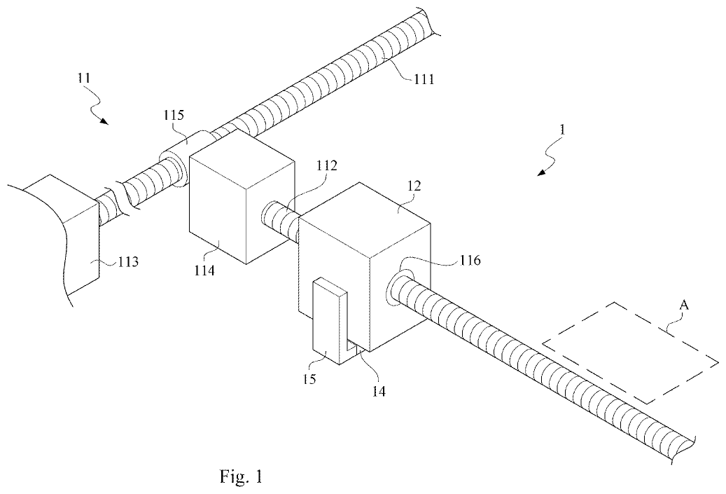

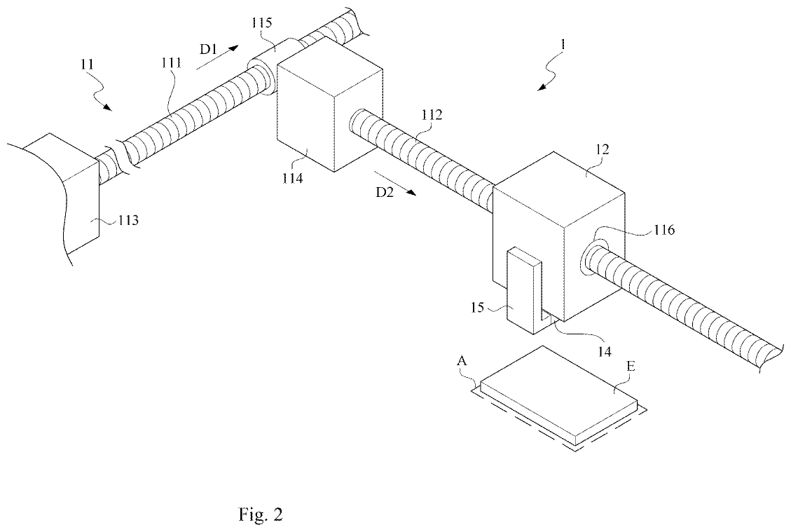

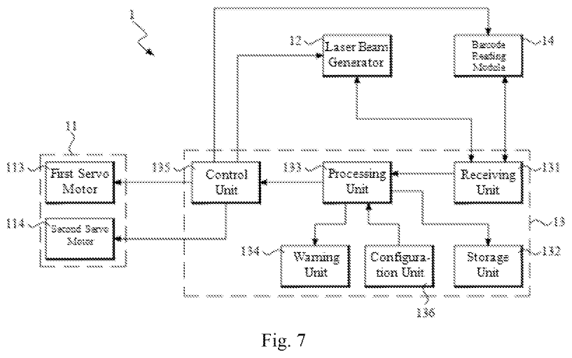

Reference is now made to FIG. 1, a schematic stereoscopic view of an embodiment of the present invention, and to FIG. 2, a diagram schematically illustrating movement of a laser engraver to an engraving area according to an embodiment of the present invention. As shown, the laser engraver 1 includes a motion assembly 11, a laser beam generator 12, a control module 13 (see FIG. 7), a barcode reading module 14 and a fastener 15.

The motion assembly 11 is operative to move in a first horizontal direction D1 and a second horizontal direction D2. In this embodiment, the motion assembly 11 includes a first rod 111, a second rod 112, a set of servo motors, a first slide member 115 and a second slide member 116. The set of servo motors includes a first servo motor 113 and a second servo motor 114. Each of the first rod 111 and the second rod 112 may be a ballscrew rod.

The laser beam generator 12 is coupled to the motion assembly 11 so as to be moveable with the motion assembly 11.

The control module 13 is electrically connected to the laser beam generator 12.

The barcode reading module 14 is disposed in correspondence with the laser beam generator 12. In this embodiment, the barcode reading module 14 is attached to the laser beam generator 12 by the fastener 15 so that when the laser beam generator 12 moves with the motion assembly 11, the barcode reading module 14 also moves therewith.

More specifically, the first servo motor 113 is able to drive rotation of the first rod 111, which causes the first slide member 115 to move in the first horizontal direction D1. The second servo motor 114 is attached to the first slide member 115 and thus moves with the first slide member 115 in the first horizontal direction D1. The second servo motor 114 is able to drive rotation of the second rod 112, which causes the second slide member 116 to move in the second horizontal direction D2. In this way, the laser beam generator 12 attached to the second slide member 116 is operative to move in the first and second horizontal directions D1 and D2 above an engraving area A where an electronic component E is placed. In this embodiment, the electronic component E is shown as a circuit board, by way of example, and not by way of limitation.

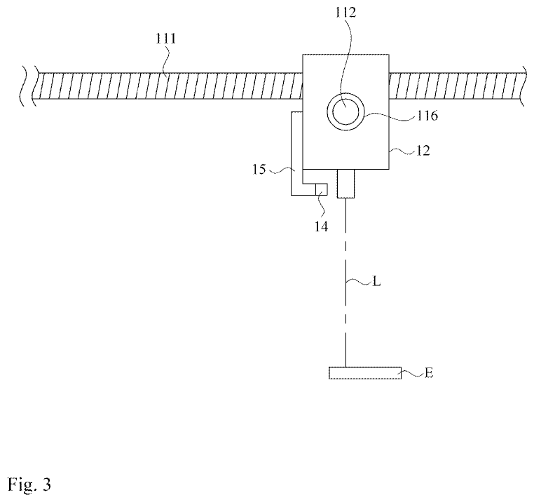

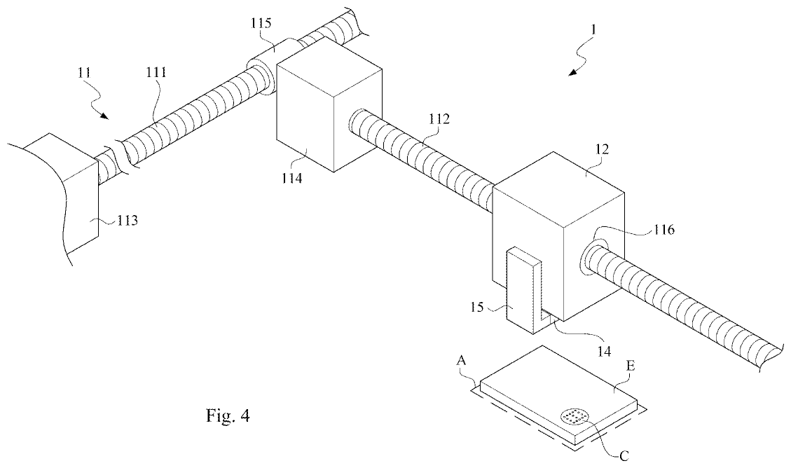

Reference is now made to FIG. 3, a diagram schematically illustrating the generation of a laser beam by the laser beam generator according to an embodiment of the present invention, FIG. 4, a diagram schematically illustrating the engraving of a two-dimensional (2D) barcode by the laser beam generator according to an embodiment of the present invention, and FIG. 7, a block diagram of the laser engraver incorporating the barcode reading module according to an embodiment of the present invention. As shown, the control module 13 includes a receiving unit 131, a storage unit 132, a processing unit 133, a warning unit 134 and a control unit 135. The processing unit 133 is electrically connected to each of the receiving unit 131, the storage unit 132, the warning unit 134, the control unit 135 and a configuration unit 136.

In this embodiment, the control unit 135 is electrically connected to both the first servo motor 113 and the second servo motor 114 so as to control operation of the first servo motor 113 and the second servo motor 114 to enable the above-described movement of the laser beam generator 12.

When the laser beam generator 12 moves above the engraving area A, the control unit 135 instructs the laser beam generator 12 to generate a laser beam L and further instructs the laser beam generator 12 to create a 2D barcode C on the electronic component E with the laser beam L, as shown in FIG. 4.

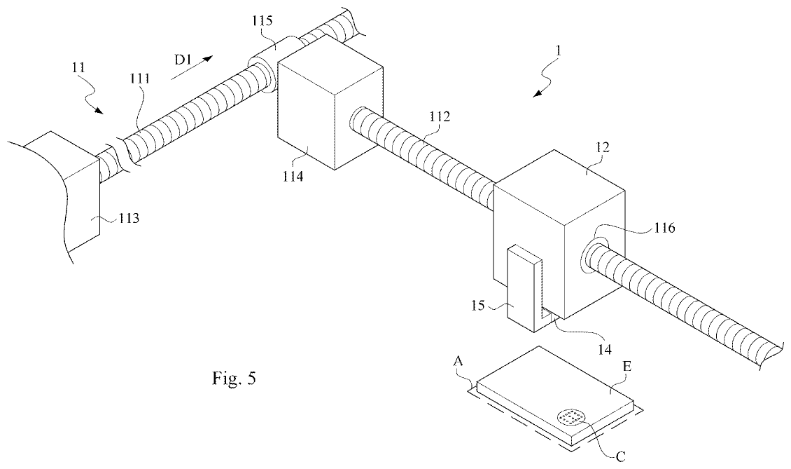

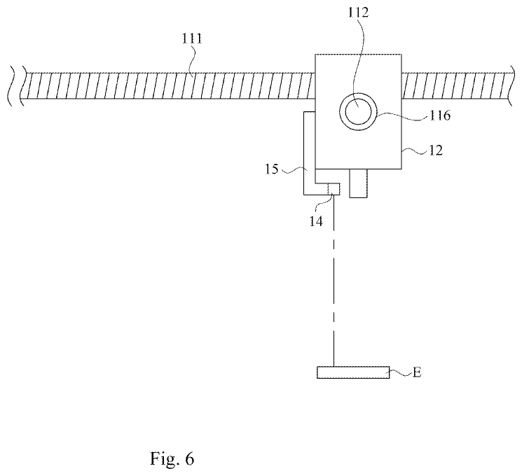

Reference is now made to FIGS. 5 to 7. FIG. 5 is a diagram schematically illustrating the movement of the barcode reading module according to an embodiment of the present invention, and FIG. 6 is a diagram schematically illustrating the reading of the 2D barcode by the barcode reading module according to an embodiment of the present invention.

After the engraving of the 2D barcode C is completed, the laser beam generator 12 produces a signal indicative of the completion, which is then received by the receiving unit 131 and authenticated by the processing unit 133. The control unit 135 then controls the motion assembly 11, more precisely, the first servo motor 113 to cause the barcode reading module 14 to move above the engraving area A, more precisely, above the 2D barcode C, as shown in FIGS. 5 and 6. After that, the control unit 135 further controls the barcode reading module 14 to read the 2D barcode C. If the reading is successful, the control unit 135 provides the read information.

In this embodiment, the read information is a serial number, which is received by the receiving unit 131, authenticated by the processing unit 133 and stored in the storage unit 132.

The receiving unit 131 also receives a count of unsuccessful attempts of the barcode reading module 14 to read the 2D barcode. If the processing unit 133 determines that the number reaches a built-in failure count, the warning unit 134 will issue a warning signal in the form of a sound, light or text, which indicates that the 2D barcode C cannot be read by the barcode reading module 14. When this happens, a technician on the site may troubleshoot the warning. The built-in failure count may be configured by the configuration unit 136.

In this embodiment, the barcode reading module 14 may be a barcode reader with a high identification rate, a low-cost barcode reader, or a barcode reader commonly used by clients in the art. In practice, CCD cameras and Honeywell barcode scanners are usually in the applicants' factory, while Keyence SR-710 ultra-compact fixed-mount barcode readers are often used by the clients. Therefore, with the present invention, the number and cost of CCD cameras and Honeywell barcode scanners for reading 2D barcodes C used in a factory can be reduced, and successful reading of 2D barcodes C by barcode readers used by clients can be ensured.

When the barcode reading module 14 cannot read the 2D barcode C, it means that it is nor readable by the client. In other words, if the barcode reading module 14 successfully reads the 2D barcode C, it means that when the electronic component E is delivered to the client, the 2D barcode C can also be successfully read by the client. This can solve the prior-art problems arising from failure in reading of 2D barcodes C by a client, including downtime of a production line and the resulting fines.

In summary, compared to the prior art, the barcode reading module in the proposed laser engraver can preliminarily read a 2D barcode engraved by the laser beam generator, and when failure in reading is determined, a warning signal can be produced to indicate that the created 2D barcode is problematic, possibly followed by troubleshooting by a technician on the site. In other words, if the preliminary reading of a 2D barcode by the barcode reading module succeeds, it means that the 2D barcode can also be successfully read by the client. This can solve the prior-art problems arising from failure in reading of 2D barcodes C by a client, including downtime of a production line and the resulting fines.

The foregoing detailed description of the preferred embodiments is intended to more clearly describe the features and spirit of the present invention but not limit the scope thereof to those embodiments disclosed hereinabove. Rather, it is intended that all changes and equivalent arrangements are also embraced within the scope of the present invention.

What is claimed is:

1. A laser engraver with a barcode reading module, for engraving a two-dimensional barcode on an electronic component positioned in an engraving area, the laser engraver comprising:
a motion assembly operative to move in a first horizontal direction and a second horizontal direction;
a laser beam generator coupled to the motion assembly, the laser beam generator operative to move above the engraving area, generate a laser beam that engraves the two-dimensional barcode on the electronic component, and after the engraving of the two-dimensional barcode is completed, produce a signal indicative of the completion;
a control module electrically connected to the laser beam generator, the control module configured to produce a barcode read signal upon receiving the signal indicative of the completion; and
the barcode reading module, which is operative to, upon receiving the barcode read signal, move above the engraving area, read the two-dimensional barcode, and in the event of the reading being successful, providing a read information, wherein in the event of a count of unsuccessful attempts to read the two-dimensional barcode reaching a built-in failure count, the control module produces a warning signal.

2. The laser engraver with the barcode reading module of claim 1, wherein the motion assembly comprises:
a first rod operative to cause the laser beam generator to move in the first horizontal direction; and
a second rod coupled to the first rod, the second rod operative to cause the laser beam generator to move in the second horizontal direction.

3. The laser engraver with the barcode reading module of claim 2, wherein both the first and second rods are ballscrew rods.

4. The laser engraver with the barcode reading module of claim 2, wherein the motion assembly comprises a set of servo motors, which are electrically connected to the control module and configured to drive the first and second rods to move under the control of the control module.

5. The laser engraver with the barcode reading module of claim 4, wherein the set of servo motors includes a first servo motor for driving the first rod and a second servo motor for driving the second rod.

6. The laser engraver with the barcode reading module of claim 1, wherein the control module comprises:
a receiving unit electrically connected to both the laser beam generator and the barcode reading module, the receiving unit configured to receive the signal indicative of the completion, the read information and the count of unsuccessful attempts of the barcode reading module to read the two-dimensional barcode;
a processing unit electrically connected to the receiving unit, the processing unit configured to receive and process the signal indicative of the completion, the read information and the count of unsuccessful attempts of the barcode reading module to read the two-dimensional barcode; and
a warning unit electrically connected to the processing unit, the warning unit configured to produce the warning signal in the event of the processing unit determining that the count of unsuccessful attempts to read the two-dimensional barcode reaches the built-in failure count.

7. The laser engraver with the barcode reading module of claim 6, wherein the control module further comprises a storage unit, which is electrically connected to the processing unit and configured to store the read information received by the processing unit.

8. The laser engraver with the barcode reading module of claim 6, wherein the control module further comprises a control unit, which is electrically connected to the processing unit and configured to control the motion assembly to move in the first horizontal direction and the second horizontal direction, control the laser beam generator to generate the laser beam, and upon the processing unit receiving the signal indicative of the completion, control the barcode reading module to move above the engraving area and read the two-dimensional barcode.

9. The laser engraver with the barcode reading module of claim 6, wherein the control module further comprises a configuration unit, which is electrically connected to the processing unit and configured to configure the built-in failure count for the barcode reading module.

10. The laser engraver with the barcode reading module of claim 1, further comprising a fastener attaching the laser beam generator to the barcode reading module.
